(19) United States
(12) Patent Application Publication
(10) Pub. No.: US 2019/0373673 A1
(43) Pub. Date: Dec. 5, 2019

(54) HIGHLY INTEGRATED SMART TRUNKING MICROWAVE DIGITAL RADIO ARCHITECTURE

(71) Applicant: ZTE CORPORATION, Shenzhen (CN)

(72) Inventors: Ying SHEN, Chapel Hill, NC (US); Ed John NEALIS, Cary, NC (US); Thanh NGUYEN, Cary, NC (US)

(73) Assignee: ZTE CORPORATION, Shenzhen (CN)

(21) Appl. No.: 16/068,061

(22) PCT Filed: Jan. 3, 2017
(86) PCT No.: PCT/US2017/012055

§ 371 Date: Jul. 3, 2018

Related U.S. Application Data
(60) Provisional application No. 62/274,721, filed on Jan. 4, 2016.
(60) Provisional application No. 62/274,725, filed on Jan. 4, 2016.

(51) Int. Cl. H04W 84/08; H04B 1/00; H04B 1/10; H04B 1/48; H01Q 21/28; H04L 27/36; H04L 5/00

(52) U.S. Cl. CPC H04W 84/08; H04B 1/006; H04B 1/10; H04L 5/001; H01Q 21/28; H04L 27/366; H04B 1/48

(57) ABSTRACT

With the introduction of this two channel aggregation RFU architecture, a series of new trunking configurations are proposed. Comparing with existing tracking radio configurations, this two channel aggregation radio architecture has the following key advantages: compact 4+0, 6+0 and N+0 trunking radio architectures; an innovative compact 2+2 XPIC trunking radio architecture; a new 2+0 standby radio architecture; an extremely compact N+0 and N+N radio architectures; 5. the feasibility of many higher order N+0 and N+N XPIC compact configurations; the feasibility and possibility that the whole trunking radio can be directly mounts to the antenna, largely boosts the overall system gain by removing this flexible waveguide between antenna and traditional trunking radio. Single two-channel aggregated RFU with two-channel aggregated modem can support up to 4 56 MHz RF channels. With 4096QAM modulation, single RFU can support up to 2.5 Gbits/s throughput.

### TECHNICAL FIELD

This application generally relates to wireless telecommunication and particularly relates to highly integrated smart trunking microwave digital radio architecture.

### BACKGROUND

Conventional trunking microwave radios consume vast volumes of power and space. But the current high levels of electronic integration make it possible for the entire trunking radio system to stand on a pole. Moreover, the arrival of two channel aggregation radio unit architecture can help develop more compact and elegant trunking microwave radio systems so that backbone operators can save significantly on operating expenditure because of decreased space and power requirements at their microwave radio shelters.

### SUMMARY

An object of the present application is to provide a highly integrated smart trunking microwave digital radio architecture. With the introduction of this two channel aggregation radio frequency unit (RFU) architecture, a series of new trunking configurations are proposed.

According to some embodiments of the present application, an N+0 trunking radio includes an antenna; a plurality of two-channel aggregated radio frequency units, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and an output coupling unit having multiple terminals, wherein each terminal is coupled to one of the integrated circulator of a respective two-channel aggregated radio frequency unit and the antenna.

According to some embodiments of the present application, a 2+2 XPIC trunking radio includes: an antenna; a plurality of two-channel aggregated radio frequency units, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and an orthomode transducer having multiple terminals, wherein each terminal is coupled to one of the integrated circulator of a respective two-channel aggregated radio frequency unit and the antenna.

According to some embodiments of the present application, a 2+0 standby radio includes: an antenna; a first two-channel aggregated radio frequency unit and a second two-channel aggregated radio frequency unit, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and a coupler having multiple terminals, wherein each terminal is coupled to one of the integrated circulator of a respective two-channel aggregated radio frequency unit and the antenna.

### BRIEF DESCRIPTION OF DRAWINGS

The accompanying drawings, which are included to provide a further understanding of the embodiments and are incorporated herein and constitute a part of the specification, illustrate the described embodiments and together with the description serve to explain the underlying principles. Like reference numerals refer to corresponding parts.

FIG. 1 is a block diagram illustrating a radio frequency unit (RFU) with two channel aggregation according to some embodiments of the present application.

FIG. 2 is a block diagram illustrating a 4+0 trunking radio using the two channel aggregated RFUs according to some embodiments of the present application.

FIG. 3 illustrates an exploded view of the 4+0 trunking radio according to some embodiments of the present application.

FIG. 4 illustrates a 2+2 XPIC trunking radio system using the two channel aggregation RFUs according to some embodiments of the present application.

FIG. 5 is a block diagram of a 2+0 hot standby configuration according to some embodiments of the present application.

FIG. 6 depicts a new dual channel modem configuration according to some embodiments of the present application.

FIG. 7 illustrates: (a) a 2+0 configuration using a dual channel modem and an aggregated dual RF channel; and (b) a 2+0 configuration using a dual channel modem and a single RF channel according to some embodiments of the present application.

FIG. 8 illustrates a 3+0 configuration using a two channel aggregated modem according to some embodiments of the present application.

FIG. 9 illustrates a 4+0 configuration using a two channel aggregated modem according to some embodiments of the present application.

FIG. 10 illustrates a 6+0 configuration using a dual channel modem according to some embodiments of the present application.

FIG. 11 illustrates a 4+4 XPIC configuration using dual channel modem according to some embodiments of the present application.

FIG. 12 illustrates a 4+0 Standby configuration using dual channel modem according to some embodiments of the present application.

### DETAIL DESCRIPTIONS

Reference will now be made in detail to embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. With reference now to the figures, exemplary block diagrams of data processing environments are provided in which illustrative embodiments may be implemented. It should be appreciated that these figures are only exemplary and are not intended to assert or imply any limitation with regard to the environments in which different embodiments may be implemented. Many modifications to the depicted environments may be made.

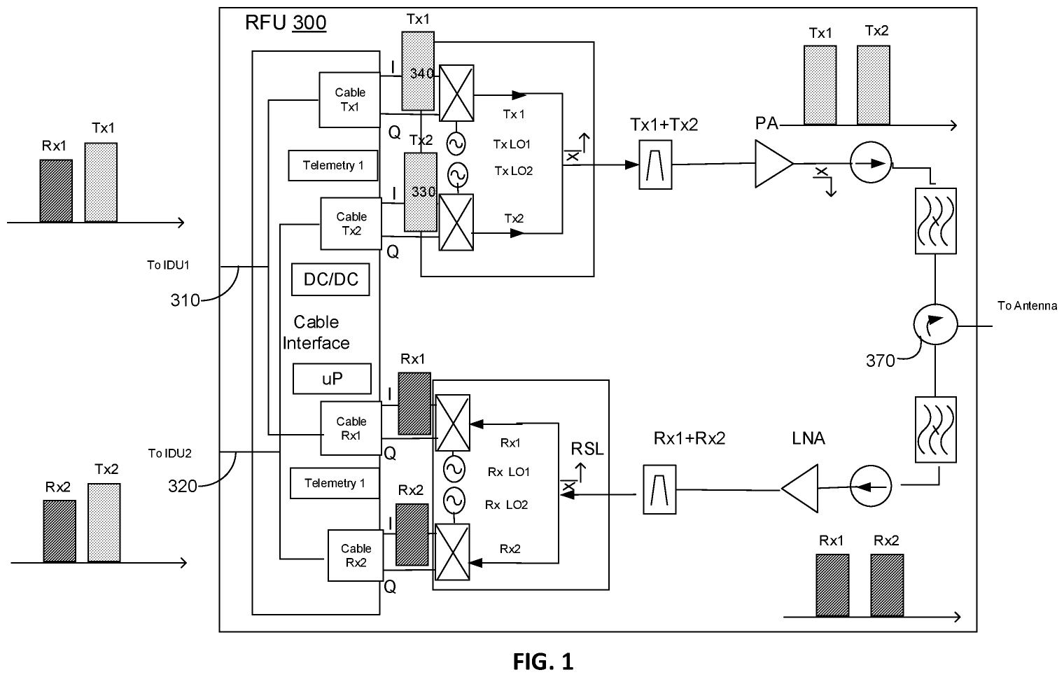

FIG. 1 depicts a two-channel aggregated radio frequency unit (RFU) 300 according to some embodiments of the present application. As shown in FIG. 1, there are two cables 310 and 320 connecting the RFU 300 directly to two modem cards in an indoor unit (IDU) (not shown in FIG. 1). The two channels from transmitters 330 and 340 are combined into a common RF chain, then to the antenna output. Similarly, for the receiver side, the antenna receives signals from two channels combined in one RF chain at another ODU (not shown in FIG. 1), which are then split into two baseband Rx signals. Note that two channels can be either side by side or at certain channel spacing. As shown in the FIG. 1, the RFU 300 includes an integrated circulator 370, which offers a better isolation between transmitter (Tx) and receiver (Rx) and a better return loss at the antenna port and relaxes the rejection requirement for both the Tx and Rx filters.

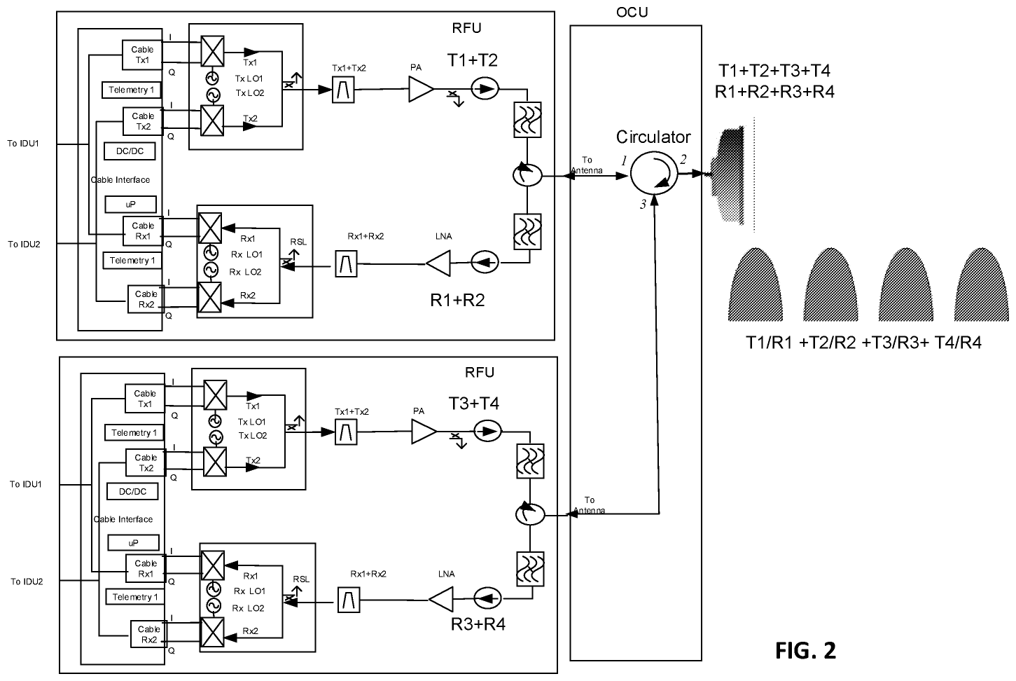

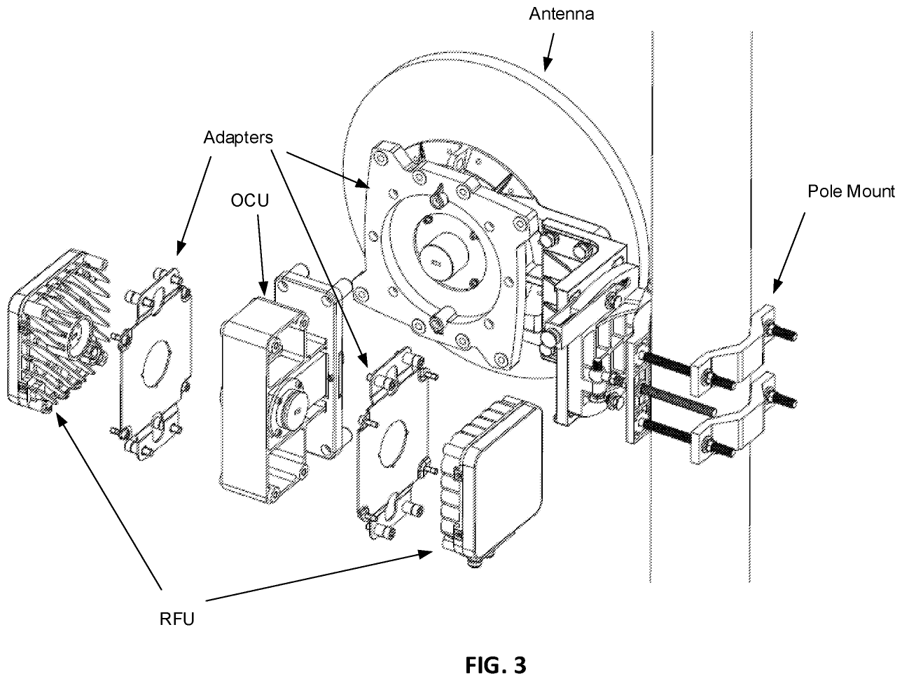

FIG. 2 shows a 4+0 trunking radio system using the two channel aggregation RFU architecture according to some embodiments of the present application. As shown in FIG. 2, each RFU carries two RF channels and the 4+0 trunking radio system only needs two RFUs. In this 4+0 trunking configuration, the output coupling unit (OCU) is a circulator. FIG. 3 shows an exploded view of this proposed 4+0 trunking radio system.

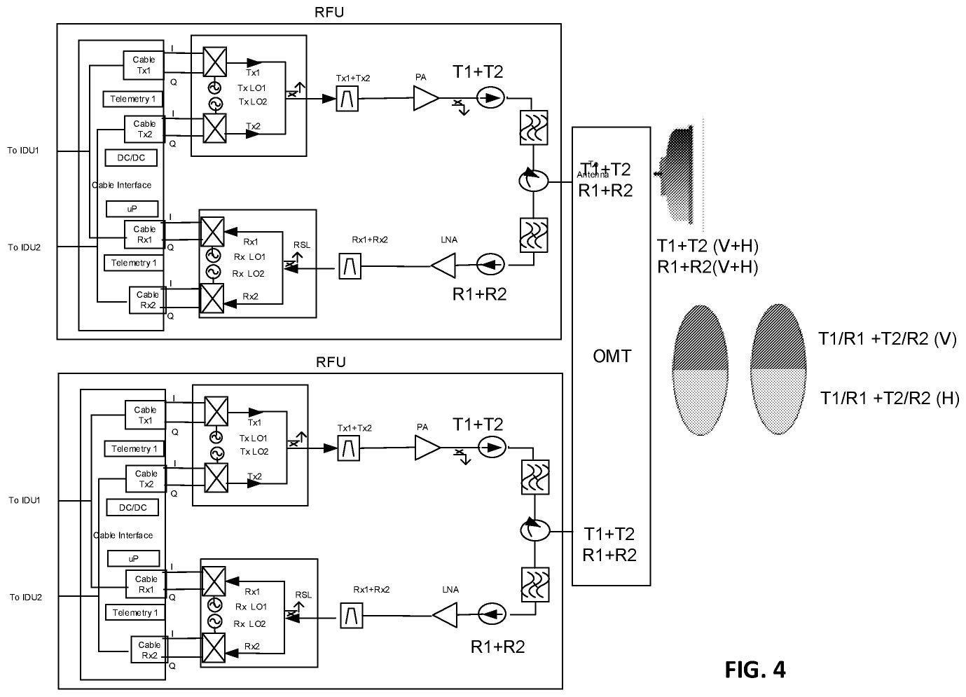

With this two channel aggregation radio architecture, a new compact 2+2 cross polarization interference cancellation (XPIC) trunking radio architecture is shown in FIG. 4. Note that the circulator shown in FIG. 2 is replaced with an orthomode transducer (OMT) in FIG. 4. But similar to the 4+0 RFU configuration described above in connection with FIG. 2, the significant reduction in size and weight makes it possible for directly integrating this new proposed 2+2 XPIC trunking system with the antenna.

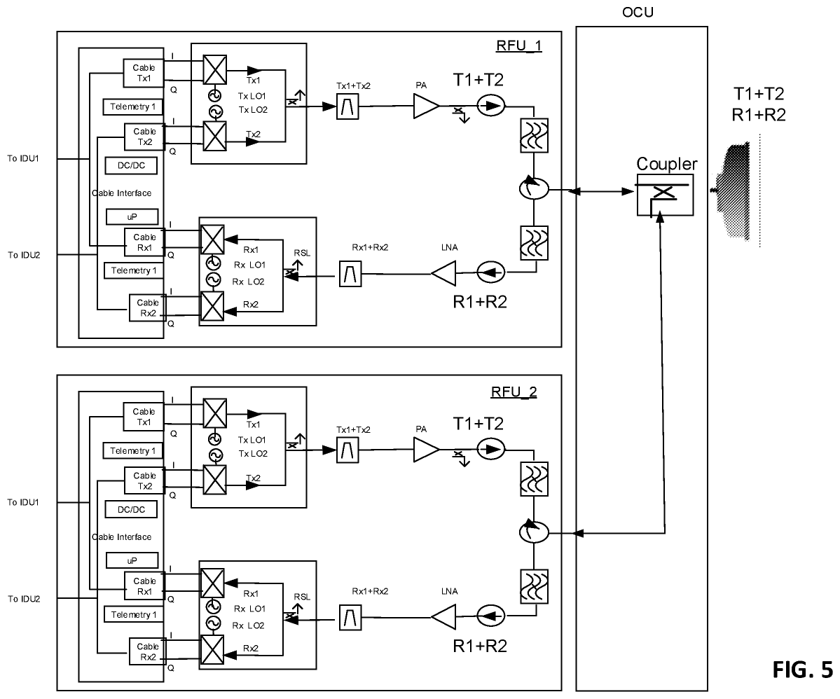

FIG. 5 depicts a block diagram of a 2+0 standby configuration using the two channel aggregation radio architecture. In this example, RFU_1 runs in the normal mode, and transmits either single or dual carriers. RFU_2 is in the muted mode. Whenever there is a failure in RFU 1, RFU_2 turns on and works as a system standby channel. RFU_1 and RFU_2 connect through either an equal or unequal coupler.

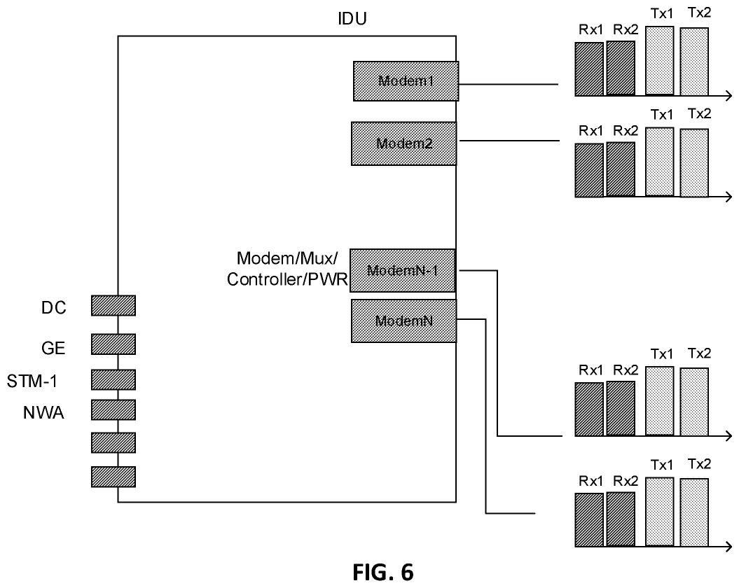

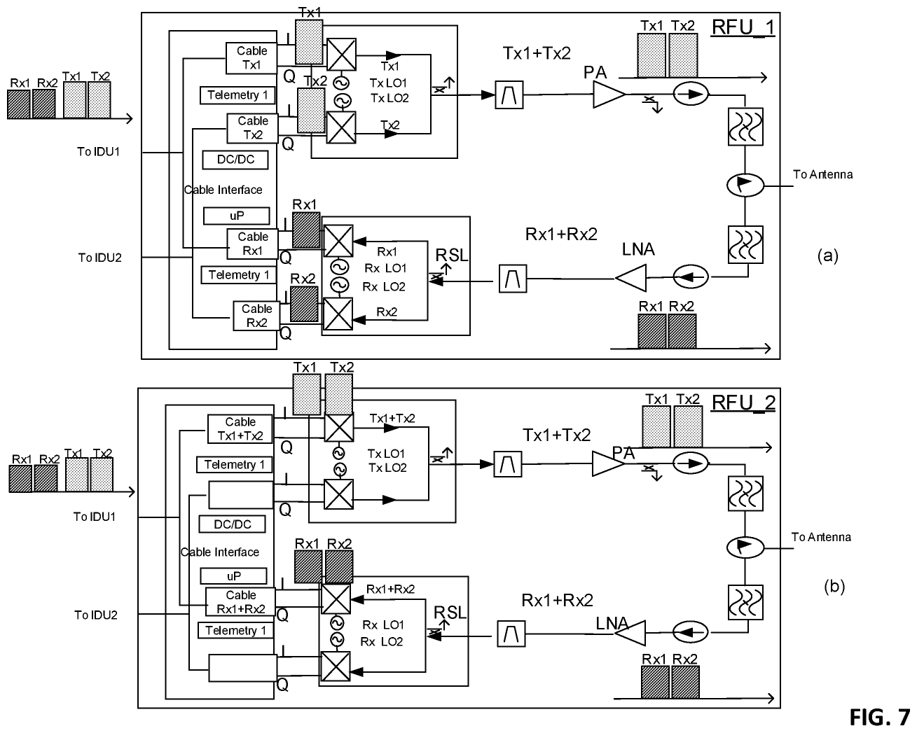

Similar to the two aggregated RF channel configuration, FIG. 6 depicts a new dual channel modem configuration. The modem can have two aggregated channel or a dual channel from each modem output. FIG. 7 shows (a) a 2+0 configuration using a dual channel modem and an aggregated dual RF channel (b) A 2+0 configuration using a dual channel modem and a single RF channel.

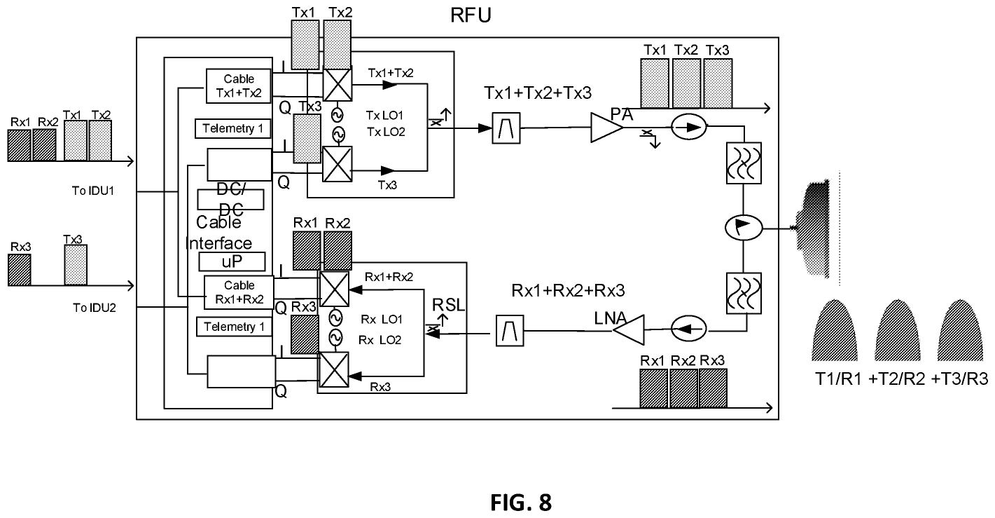

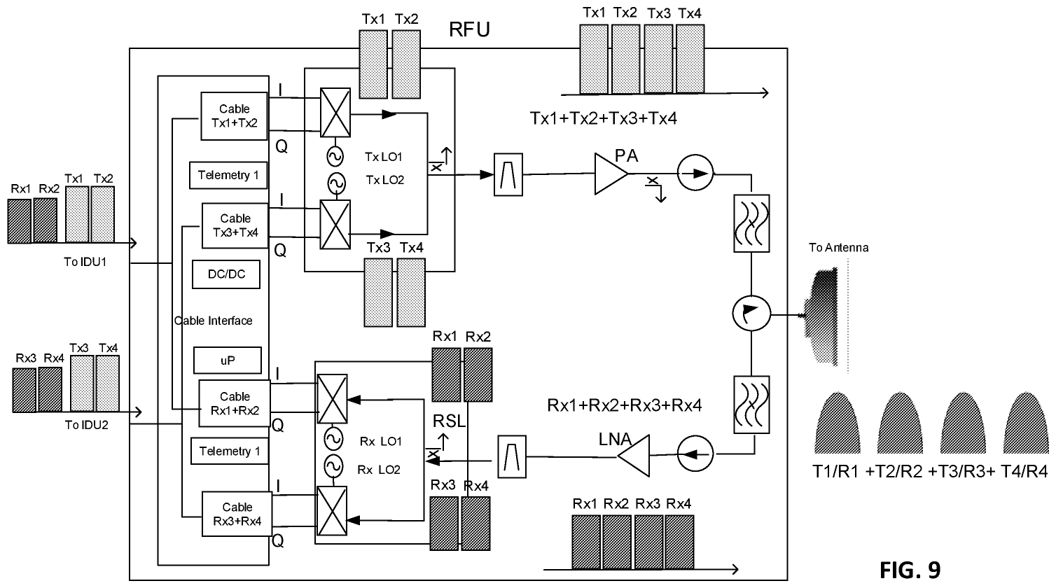

FIG. 8 shows a 3+0 configuration using this dual modem configuration. The first RF input is from a dual channel modem and the second RF input is from a single channel modem. FIG. 9 shows a similar 4+0 configuration with this dual channel modem. Comparing with the 4+0 trunking radio shown in FIG. 2, this 4+0 configuration uses only one RFU. There is no need for 2nd RFU or an external circulator. In other words, a single RFU can support a maximum of 4 RF channels.

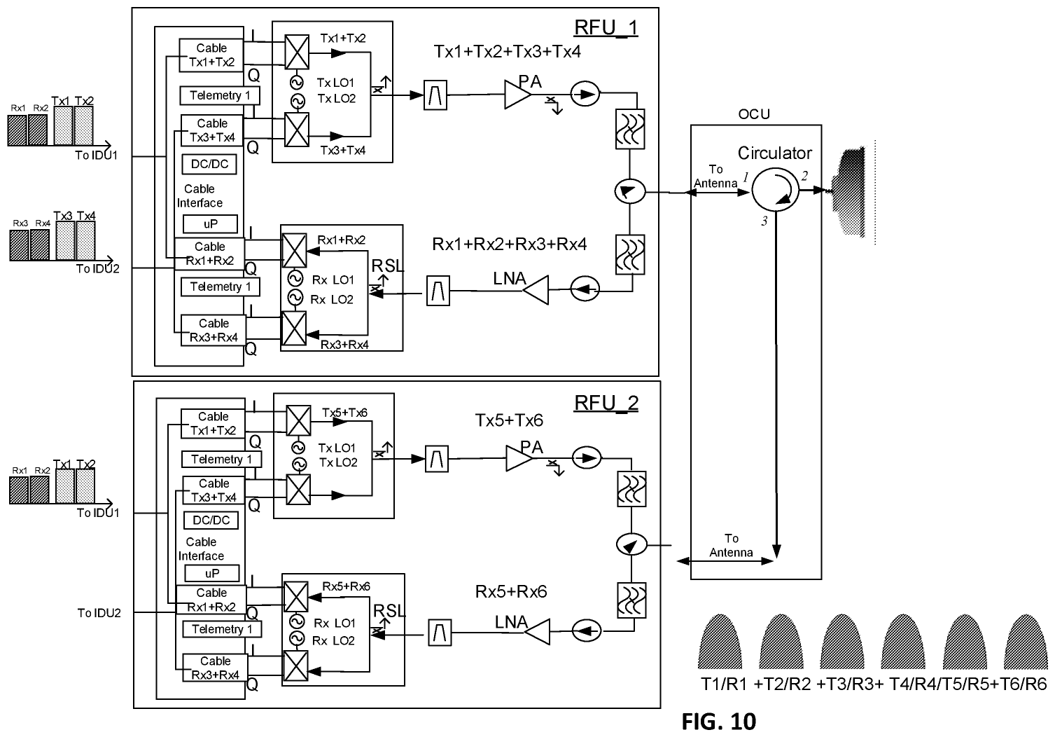

FIG. 10 shows a 6+0 configuration with this dual channel modem. Furthermore, using this two channel aggregated modem, N+N configuration becomes extremely compact and saves cost and space greatly.

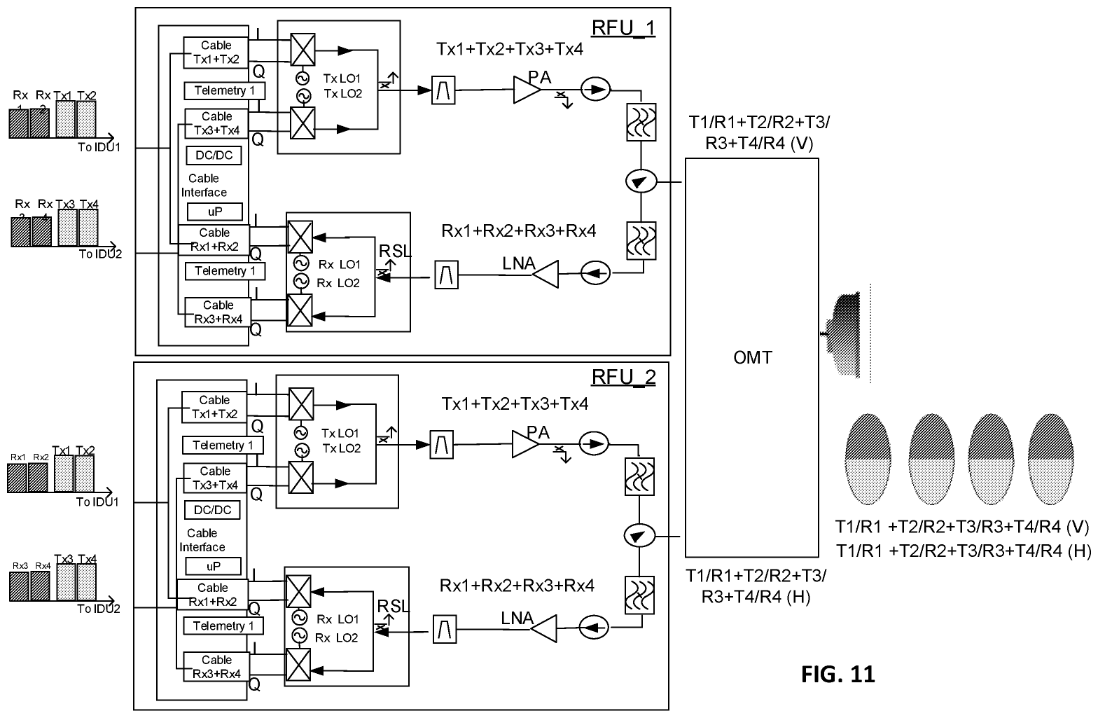

FIG. 11 shows an example of 4+4 XPIC configuration. One radio provides 4-channel aggregated radio in vertical direction, and the other radio provides the same 4-channel aggregated radio in horizontal direction.

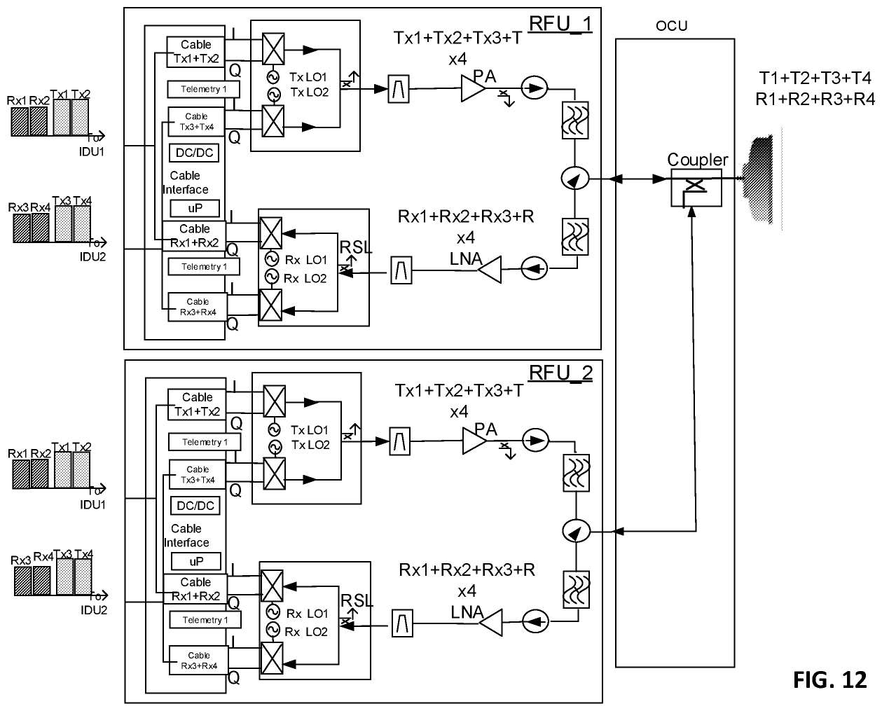

FIG. 12 shows a 4+0 standby configuration. In the normal operation, one 4 channel RFU is working the other 4 channel RFU is muted and as a standby RFU. In the case of any hardware failure in the working RFU, the 2nd RFU will kick in as the hardware replacement while fixing or replace for the 1st failed unit.

Using this dual aggregated modem concept, a single two-channel aggregated RFU can support up to 4 channels. By using this combination of two-channel aggregated modem and two-channel aggregated RFU, the following restriction applies:
The total bandwidth of the dual modem output needs to be less than 112 MHz;
The total bandwidth of the four channel of each RF output needs to be less than ADAD effective bandwidth;
The Pout of each RF channel (assuming 4 channels out from each RF chain) will be 6 dB less than a single channel maximum Pout.

The description of the present application has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

The terminology used in the description of the embodiments herein is for the purpose of describing particular embodiments only and is not intended to limit the scope of claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will also be understood that, although the terms first, second, etc. may be used herein to describe various elements, these elements should not be limited by these terms. These terms are only used to distinguish one element from another. For example, a first port could be termed a second port, and, similarly, a second port could be termed a first port, without departing from the scope of the embodiments. The first port and the second port are both ports, but they are not the same port.

Many modifications and alternative embodiments of the embodiments described herein will come to mind to one skilled in the art having the benefit of the teachings presented in the foregoing descriptions and the associated drawings. Therefore, it is to be understood that the scope of claims are not to be limited to the specific examples of the embodiments disclosed and that modifications and other embodiments are intended to be included within the scope of the appended claims. Although specific terms are employed herein, they are used in a generic and descriptive sense only and not for purposes of limitation.

The embodiments were chosen and described in order to best explain the underlying principles and their practical applications, to thereby enable others skilled in the art to best utilize the underlying principles and various embodiments with various modifications as are suited to the particular use contemplated.

What is claimed is:

1. An N+0 trunking radio, comprising:
an antenna;
a plurality of two-channel aggregated radio frequency units, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and
an output coupling unit having multiple terminals, wherein each terminal is coupled to one of the integrated circulator of a respective two-channel aggregated radio frequency unit and the antenna.

2. The N+0 trunking radio of claim 1, wherein each two-channel aggregated radio frequency unit further includes:
a cable interface;
a radio frequency processing section; and
an antenna coupling section, wherein:
the cable interface includes two cables, each cable configured to receive an analog intermediate frequency signal from a modem output at a remote indoor microwave radio;
the radio frequency processing section configured to process the two analog intermediate frequency signals into one analog radio frequency signal; and
the antenna coupling section includes a co-plane circulator for connecting to the output coupling unit and transmitting the analog radio frequency signal using the antenna.

3. A 2+2 XPIC trunking radio, comprising:
an antenna;
a plurality of two-channel aggregated radio frequency units, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and
an orthomode transducer having multiple terminals, wherein each terminal is coupled to one of the integrated circulator of a respective two-channel aggregated radio frequency unit and the antenna.

4. The 2+2 XPIC trunking radio of claim 3, wherein each two-channel aggregated radio frequency unit further includes:
a cable interface;
a radio frequency processing section; and
an antenna coupling section, wherein:
the cable interface includes two cables, each cable configured to receive an analog intermediate frequency signal from a modem output at a remote indoor microwave radio;
the radio frequency processing section configured to process the two analog intermediate frequency signals into one analog radio frequency signal; and
the antenna coupling section includes a co-plane circulator for connecting to the output coupling unit and transmitting the analog radio frequency signal using the antenna.

5. A 2+0 standby radio, comprising:
an antenna;
a first two-channel aggregated radio frequency unit and a second two-channel aggregated radio frequency unit, each two-channel aggregated radio frequency unit including two channels from a pair of transmitters combined into a first common radio frequency chain, two channels from a pair of receivers split from a second common radio frequency chain, and an integrated circulator coupling to the two pairs of channels; and
a coupler having multiple terminals, wherein each terminal is coupled to one of the integrated circulator of a respective two-channel aggregated radio frequency unit and the antenna.

6. The 2+0 standby radio of claim 5, wherein each two-channel aggregated radio frequency unit further includes:
a cable interface;
a radio frequency processing section; and
an antenna coupling section, wherein:
the cable interface includes two cables, each cable configured to receive an analog intermediate frequency signal from a modem output at a remote indoor microwave radio;
the radio frequency processing section configured to process the two analog intermediate frequency signals into one analog radio frequency signal; and
the antenna coupling section includes a co-plane circulator for connecting to the output coupling unit and transmitting the analog radio frequency signal using the antenna.

7. The 2+0 standby radio of claim 5, wherein the first two-channel aggregated radio frequency unit runs in a normal mode and the second two-channel aggregated radio frequency unit runs in a muted mode.
